(19) United States
(12) Patent Application Publication
(10) Pub. No.: US 2023/0364838 A1
(43) Pub. Date: Nov. 16, 2023

(54) MOLD INSERT FOR A TOOLING DEVICE FOR PRODUCING AN OPTICAL COMPONENT BY INJECTION MOLDING, AND TOOLING DEVICE HAVING SUCH A MOLD INSERT

(71) Applicant: HELLA GmbH & Co. KGaA, Lippstadt (DE)

(72) Inventor: Dietmar HAUT, Lippstadt (DE)

(73) Assignee: HELLA GmbH & Co. KGaA, Lippstadt (DE)

(21) Appl. No.: 18/195,217

(22) Filed: May 9, 2023

(30) Foreign Application Priority Data
May 10, 2022 (DE) 10 2022 111 616.6

(51) Int. Cl. B29C 45/14; B29D 11/00

(52) U.S. Cl. CPC B29C 45/14778; B29D 11/00432; B29D 11/00269; B29D 11/00365; B29L 2011/005

(57) ABSTRACT

A mold insert for a tooling device for producing an optical component by injection molding, wherein the mold insert is formed at least in part of copper beryllium.

This nonprovisional application claims priority under 35 U.S.C. § 119(a) to German Patent Application No. 10 2022 111 616.6, which was filed in Germany on May 10, 2022, and which is herein incorporated by reference.

### BACKGROUND OF THE INVENTION

### Field of the Invention

The present invention relates to a mold insert for a tooling device for producing an optical component by injection molding, a tooling device and a method for producing such a mold insert.

### Description of the Background Art

Optical components such as lenses for a headlight of a motor vehicle are often manufactured in the prior art from transparent plastics by injection molding. For example, polycarbonate (PC) and polymethyl methacrylate (PMMA) are used. The mold inserts for the tooling device with which the optical components are injected are usually made of steel in the prior art. Steel has a high degree of hardness, so that it is almost impossible to produce the mold inserts by milling processes. Milling the steel leads to unacceptable geometrical deviations of the optical components from the desired ideal geometry due to the hardness and fracture properties of the steel. Furthermore, milling tools, with which the surface of the steel is machined, wear out very quickly. This can also lead to undesirable geometrical deviations of the optical components from the ideal geometry because the properties of the milling tool used can change in the course of milling a mold insert. Therefore, in the prior art, mold inserts made of steel are produced by a 3D printing process, which, however, is a very cost-intensive manufacturing process.

Furthermore, the use of steel mold inserts produced by 3D printing process in the injection molding of complex or high-precision optical components leads to undesirable geometrical deviations of the optical components from the ideal geometry. The reason, in particular, is the low thermal conductivity of typical steels, which leads to different temperatures in different subregions of the surfaces of the mold insert facing the cooling optical component when cooling the mold insert after injecting the optical component. This can result in distortion or deformation of the optical component.

Geometric deviations of the optical component from the desired ideal geometry prove to be very disadvantageous, especially in components of a lighting device for a motor vehicle, such as components for a headlight, because photometrically relevant components that are not precisely molded cannot be tested individually, but only when installed in the lighting system, in particular in the headlight. This means that possible error indications can only be recorded at a later point in time and with a great expenditure of time and costs. Typical error indications in a headlight lead, for example, to unplanned light losses, rework costs and time. In addition, as a result of the necessary manual rework, there is both the risk of uneven surface quality and the risk of geometric deviations such as rounding of originally sharp-edged optics.

### SUMMARY OF THE INVENTION

It is therefore an object of the present invention to provide a mold insert and/or a tooling device, with which an optical component can be manufactured cost-effectively and/or precisely by injection molding. Furthermore, a method of the type mentioned above is to be specified, which enables a cost-effective and/or precise production of the mold insert.

According to an exemplary embodiment, it is provided that the mold insert can be formed at least in part of copper beryllium. With such a mold insert, a high-precision impression of critical molded part geometries for photometrically relevant optical components can be realized. A lower proportion of rejects can be achieved by the high-precision impression of critical molded part geometries. Furthermore, lower unit cost prices can be achieved.

It may be provided that the copper beryllium of the mold insert has between 0.3 and 3.0 percent by weight beryllium, in particular between 1.0 and 2.5 percent by weight beryllium, preferably between 1.5 and 2.2 percent by weight beryllium, for example 1.9 percent by weight beryllium. The copper beryllium may be, for example, a material that is sold by the company Schmelzmetall under the name Hovadur K 350.

There is a possibility that the copper beryllium of the mold insert has a Brinell hardness at 20° C. between 180 HB and 500 HB, in particular between 260 HB and 450 HB, preferably between 350 HB and 410 HB, for example a Brinell hardness at 20° C. of 380 HB. This significantly lower hardness as compared to steel makes it possible to produce the complementary shape of the mold insert corresponding to the optical component to be molded, at least in part, by milling. The copper beryllium is much easier to convert into the shape required for injection molding without showing relevant deviations from the target geometry.

It may be provided that the copper beryllium of the mold insert has a thermal conductivity at 20° C. between 100 W/mK and 300 W/mK, in particular between 120 W/mK and 250 W/mK, preferably between 140 W/mK and 200 W/mK, for example a thermal conductivity at 20° C. of 160 W/mK. Due to this very high thermal conductivity as compared to steel, a homogeneous mold wall temperature and the resulting uniform heating and cooling behavior of the mold insert can be guaranteed. Furthermore, the high thermal conductivity enables faster heating and cooling of the mold insert, so that a cycle time reduction can be achieved. The cycle time reduction may also avoid having to invest in additional injection molds. Overall, this contributes to a lower unit cost price.

There is a possibility that the copper beryllium of the mold insert has a coefficient of thermal expansion at 20° C. between 14.0×10⁻⁶/K and 20.0×10⁻⁶/K, in particular between 15.0×10⁻⁶/K and 19.0×10⁻⁶/K, preferably between 16.0×10⁻⁶/K and 18.0×10⁻⁶/K, for example a coefficient of thermal expansion at 20° C. of 17.0×10⁻⁶/K. The significantly higher coefficient of thermal expansion as compared to steel facilitates the demolding of the injected optical component, particularly if the optical component has micro- or nanostructures. The mold insert, which shrinks rapidly when cooled down due to the high coefficient of thermal expansion, retracts correspondingly quickly from the structures of the optical component, so that they do not warp during demolding. This can lead to a high-precision impression of critical molded part geometries of the optical component.

It may be provided that the mold insert on the side facing the optical component to be molded is at least in part coated with nickel. The nickel coating seals the surface of the copper beryllium, which prevents the toxic beryllium from escaping. Furthermore, the nickel coating of the copper beryllium surfaces of the mold insert produces a high gloss. The coating also improves the tribological properties and ensures wear or scratch protection. In addition, the demolding of the optical components from the mold cavity is improved.

At least one of the mold inserts can be a mold insert according to the invention.

It may be provided that at least one of the mold inserts is not a mold insert according to the invention, wherein this mold insert consists in particular of steel or comprises steel. Here, for example, a mold insert made of copper beryllium can be used for a complex structured first side of the optical component, whereas a mold insert made of steel can be used, for example, for a second, slightly complex structured side of the optical component opposite the first side.

Alternatively, it may be provided that all of the mold inserts are mold inserts according to the invention.

It is possible that the tooling device is configured to produce the optical component in a single-component injection molding process, so that the optical component is injected, in particular, in one step from a material. This may be, for example, a complex optical component with micro- or nanostructures such as a Fresnel lens or a microlens array.

Also, it may be provided that the tooling device can be configured to produce the optical component in a multi-component injection molding process, so that in particular a first part of the optical component is injected in a first step from a first material and a second part of the optical component is injected in a second step from a second material. This can be, for example, a thick lens made of two different plastics such as PMMA and PC.

The side of the mold insert facing the optical component to be molded can be at least in part converted by milling into a complementary shape corresponding to the optical component to be molded. In particular, the complementary shape of the mold insert corresponding to the optical component to be molded can be achieved exclusively by milling. By milling, the mold insert can be produced much cheaper than by 3D printing.

It may be provided that the complementary shape of the mold insert corresponding to the optical component to be molded can be provided with an anti-corrosion coating after milling. This can prevent the optionally finely structured surface of the mold insert from being changed by corrosion in such a way that geometric deviations from the ideal geometry result during spraying of the optical component.

It is possible that after milling, and in particular after applying the anti-corrosion coating, the complementary shape of the mold insert corresponding to the optical component to be molded is at least in part coated with nickel. A chemical nickel coating, for example, can prevent patina formation on the optionally finely structured surface of the mold insert.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a first embodiment of an optical component which can be produced with a tooling device according to the invention;

FIG. 2 is a detail of a 3D view of the surface of the optical component according to FIG. 1;

FIG. 3 is a schematic sectional view of a detail of a tooling device according to the invention with which the optical component according to FIG. 1 can be produced, wherein the optical component is indicated in FIG. 3; and

FIG. 4 is a perspective view of a second embodiment of an optical component producible with a tooling device according to the invention.

### DETAILED DESCRIPTION

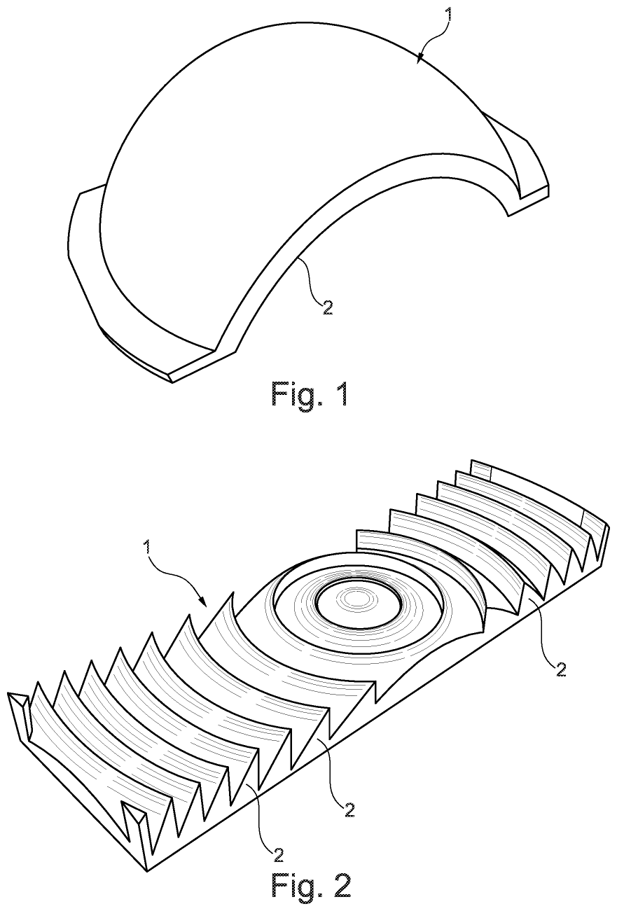

FIG. 1 and FIG. 2 show an example of an optical component producible with a tooling device according to the invention. It is a thin-walled, plastic lens 1, which is designed as a Fresnel lens. The lens 1 may be provided, for example, for a headlight of a motor vehicle. In this case, ring-shaped steps 2 forming the Fresnel structure are arranged on the inside of a dome-shaped substrate.

FIG. 2 shows the arrangement of the ring-shaped steps 2 in a sectional 3D view of the inner surface of the dome-shaped substrate. In this case, the lens 1 may have a thickness of, for example, 3 mm. Furthermore, the distances of the adjacent steps 2 to each other, for example, can be only a few tenths of a millimeter.

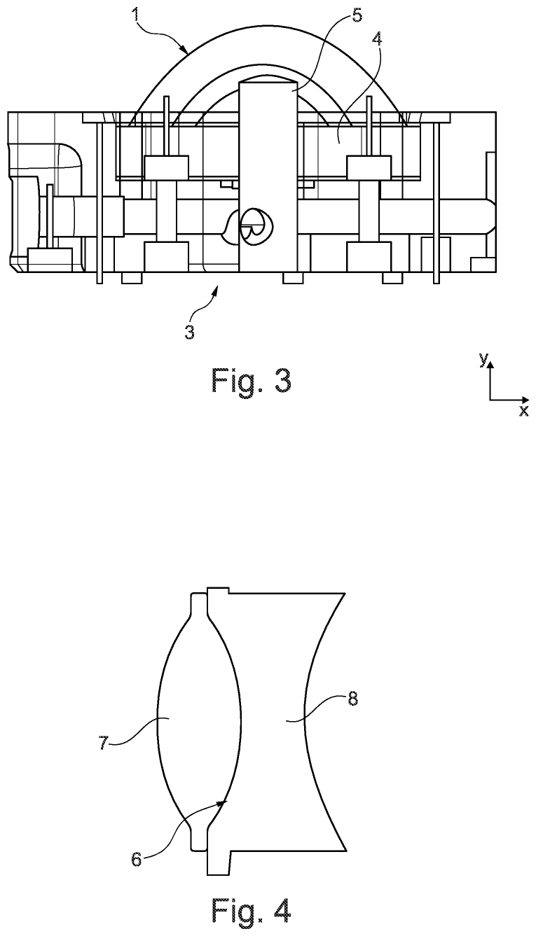

The tooling device 3 partially illustrated in FIG. 3 comprises a first mold insert 4 tooling device only schematically indicated in FIG. 3, which has, in sections, a shape complementary to the inside of the lens 1. In FIG. 3, in particular, the part of the first mold insert 4 extending into the inside of the dome-shaped substrate of lens 1 is not shown for reasons of clarity. The first mold insert 4 is formed of copper beryllium. The first mold insert 4 is coated with nickel on the side facing the lens 1 to be molded.

The tooling device 3 further comprises a cooling arrangement 5, which extends centrally into the first mold insert 4. The tooling device further comprises a second mold insert, not shown, which together with the first mold insert 4 forms the cavity for the lens 1 to be molded. The second mold insert has, in sections, a complementary shape to the outside of the lens 1 arranged at the top in FIG. 3. Since this outside of the lens 1 is smooth or without fine structures, the second mold insert may be formed of steel. Alternatively, there is the possibility that the second mold insert also is formed of copper beryllium.

Copper beryllium is an alloy of copper and beryllium. The copper beryllium used for the first mold insert 4 can in particular be a material which is marketed by the company Schmelzmetall under the name Hovadur K 350. This material has a beryllium content of 1.9 percent by weight. It also has a cobalt content of 0.3 percent by weight and a nickel content of 0.3 percent by weight. Furthermore, residues of silicon and iron are found in the material, each with a proportion of less than 0.1 percent by weight. Furthermore, other residues with a total proportion of less than 0.5 percent by weight may be present in the material. The rest is copper.

The material has a Brinell hardness at 20° C. between 350 HB and 410 HB. Furthermore, it has a thermal conductivity at 20° C. of 160 W/mK. Furthermore, the material has a coefficient of expansion at 20° C. of 17.0×10⁻⁶/K.

It is quite possible to select another copper beryllium for the mold insert instead of the specific material mentioned.

For the production of the lens 1, a transparent plastic such as polycarbonate (PC) or polymethyl methacrylate (PMMA) can be used. The plastic used for the production of lens 1 can, for example, be injected into the cavity when the first mold insert 4 and the second mold insert are heated to about 140° C. Due to the large coefficient of expansion of the first mold insert 4, it undergoes a strong shrinkage after injection of the plastic with a subsequent cooling to 20° C. For example, this shrinkage in the Y-direction, which in FIG. 3 extends in the vertical direction or in the direction in which the first mold insert 4 and the second mold insert are moved apart for demolding, is approximately 55 mm. At the same time, the first mold insert 4 shrinks in the X direction, which in FIG. 3 extends from left to right, for example by 68 mm.

The rapidly shrinking first mold insert 4 during cooling due to the high coefficient of thermal expansion retracts correspondingly quickly from the ring-shaped steps 2 of the lens 1 formed as a Fresnel lens, so that these do not warp during demolding. This leads to a high-precision impression of critical molded part geometries of the lens 1. In particular, the standard pull-out slope on the steps 2 for injection-molded parts can be minimized, ideally up to 0°.

FIG. 4 shows another example of an optical component that can be produced with a tooling device according to the invention. It is a thick-walled lens 6, which includes two different plastics. The lens 6 may serve in particular as an achromatic and may also be intended for a headlight of a motor vehicle.

The lens 6 comprises a first partial lens 7, which is produced as a biconvex lens from, for example, PMMA, and a second partial lens 8, which is manufactured as a biconcave lens from, for example, PC. The tooling device is configured for the production of this lens 6 to produce the lens 6 in a multi-component injection molding process. For example, the first partial lens 7 is injected from PMMA in a first step and the second partial lens 8 is injected from PC in a second step.

It is possible to manufacture all three of the three mold inserts necessary for these partial lenses 7, 8 from copper beryllium. Alternatively, one of the mold inserts or two of the mold inserts can be made of another material such as steel.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A mold insert for a tooling device for the production of an optical component by injection molding, wherein the mold insert is formed at least in part of copper beryllium.

2. The mold insert according to claim 1, wherein the copper beryllium of the mold insert has between 0.3 and 3.0 percent by weight beryllium, between 1.0 and 2.5 percent by weight beryllium, between 1.5 and 2.2 percent by weight beryllium, or 1.9 percent by weight beryllium.

3. The mold insert according to claim 1, wherein the copper beryllium of the mold insert has a Brinell hardness at 20° C. between 180 HB and 500 HB, between 260 HB and 450 HB, between 350 HB and 410 HB, or a Brinell hardness at 20° C. of 380 HB.

4. The mold insert according to claim 1, wherein the copper beryllium of the mold insert has a thermal conductivity at 20° C. between 100 W/mK and 300 W/mK, between 120 W/mK and 250 W/mK, between 140 W/mK and 200 W/mK, or a thermal conductivity at 20° C. of 160 W/mK.

5. The mold insert according to claim 1, wherein the copper beryllium of the mold insert has a coefficient of thermal expansion at 20° C. between 14.0×10⁻⁶/K and 20.0×10⁻⁶/K, between 15.0×10⁻⁶/K and 19.0×10⁻⁶/K, between 16.0×10⁻⁶/K and 18.0×10⁻⁶/K, or has a coefficient of thermal expansion at 20° C. of 17.0×10⁻⁶/K.

6. The mold insert according to claim 1, wherein the mold insert is at least in part coated with nickel on a side facing the optical component to be molded.

7. A tooling device for producing an optical component by injection molding, the tooling device comprising:
at least two mold inserts; between which
a cavity formed between the at least two mold inserts that are arranged adjacent to one another, the cavity being provided for molding the optical component,
wherein at least one of the mold inserts is the mold insert according to claim 1.

8. The tooling device according to claim 7, wherein at least one of the mold inserts is not a mold insert according to claim 1, wherein this mold insert consists of steel or comprises steel.

9. The tooling device according to claim 7, wherein all of the mold inserts are mold inserts according to claim 1.

10. The tooling device according to claim 7, wherein the tooling device is configured to produce the optical component in a single-component injection molding process, so that the optical component is injected in one step from a material.

11. The tooling device according to claim 7, wherein the tooling device is configured to produce the optical component in a multi-component injection molding process, so that a first part of the optical component is sprayed in a first step from a first material and a second part of the optical component is sprayed in a second step from a second material.

12. A method for producing the mold insert according to claim 1, wherein a side of the mold insert facing the optical component to be molded is at least in part converted by milling into a complementary shape corresponding to the optical component to be molded.

13. The method according to claim 12, wherein the complementary shape of the mold insert corresponding to the optical component to be molded is achieved by milling.

14. The method according to claim 12, wherein the complementary shape of the mold insert corresponding to the optical component to be molded is provided with an anti-corrosion coating after milling.

15. The method according to claim 12, wherein the complementary shape of the mold insert corresponding to the optical component to be molded is at least in part coated with nickel after milling and after applying the anti-corrosion coating.
